(19) United States
(12) Patent Application Publication
(10) Pub. No.: US 2015/0039555 A1
(43) Pub. Date: Feb. 5, 2015

(54) HEURISTICALLY MODIFYING DBMS ENVIRONMENTS USING PERFORMANCE ANALYTICS

(71) Applicant: International Business Machines Corporation, Armonk, NY (US)

(72) Inventor: Suryanarayana K. Rao, Bangalore (IN)

(73) Assignee: International Business Machines Corporation, Armonk, NY (US)

(21) Appl. No.: 13/957,909

(22) Filed: Aug. 2, 2013

(51) Int. Cl. G06F 17/30

(52) U.S. Cl. CPC G06F 17/30377
USPC 707/607

(57) ABSTRACT

Providing diagnostics for a database system including at least one database, with the database system. The diagnostics include the following steps (not necessarily in the following order): (i) determining a contribution to system workload for each contributor of a plurality of contributors; and (ii) selecting a remedial action based, at least in part, upon the contributions to system workload of the contributors. The plurality of contributors are selected as one of the following: the plurality of data-base-related operations, or the plurality of database-related transactions.

### FIELD OF THE INVENTION

The present invention relates generally to the field of tuning database management systems (DBMS), and more particularly to optimizing aggregated DBMS environments.

### BACKGROUND OF THE INVENTION

The goal of tuning a database is to maximize the use of system resources to perform work as efficiently and rapidly as possible. Most database management systems (DBMS) are designed to manage work efficiently, but there is always room for improvement, especially when it is considered how difficult it is to visualize solutions to all the possible database throughput issues and challenges that may arise in the future as the database is applied in a myriad of diverse situations.

A database application is essentially software that performs certain functions related to storing data and accessing the data on command. Business-related database applications generally try to help a business manage its interactions with their customers. One example of a business-related database (herein sometimes referred to as a “business application”) is a flight reservation business application. A flight reservation business application allows business users to access information related to flight bookings, flight scheduling, seat allocations, flight payments, etc.

Complex business environments may contain a heterogeneous set of database models, such as, but not limited to: relational databases, object-relational databases, network databases, and hierarchical databases. Databases can be used for human resources, customer information, employee tasks, marketing plans, accounting and sales.

Tuning a DBMS involves setting one, or more, database-related properties. The database-related properties, set by tuning, may include one or more of the following: updating object statistics, using custom execution plans that decrease execution times, assigning parallelism (the breaking up of work from a single query into tasks assigned to different processing resources), and network protocols (used to communicate with database consumers).

In complex business environments, more often than not, end-to-end application performance is what really determines if business service level agreements (SLAs) are being met. In these complex business environments, application and business processing is generally distributed across several disparate or interlinked databases. The throughput and response time of each component database (and the structured query language (SQL) statements and transactions executing thereon) is critical in calculating the overall throughput.

### SUMMARY

Embodiments of the present invention disclose a method, computer program product, and system for using a database. According to an aspect of the present invention, there is a method for use with a database system including at least one database, with the database system being configured to provide a single application, and with the system being subject to a plurality of database-related operations and database-related transactions. The method includes the following steps (not necessarily in the following order): (i) determining a contribution to system workload for each contributor of a plurality of contributors; and (ii) selecting a remedial action based, at least in part, upon the contributions to system workload of the contributors. The plurality of contributors are selected as one of the following: the plurality of data-base-related operations, or the plurality of database-related transactions.

### BRIEF DESCRIPTION OF THE SEVERAL VIEWS OF THE DRAWINGS

FIG. 1 is a diagram illustrating a distributed data processing environment 100, in accordance with one embodiment of the present invention.

FIG. 2A is a flowchart depicting operational steps of a CPPW (central performance predictive warehouse) program, in accordance with an embodiment of the present invention.

FIG. 2B is a flowchart depicting operational steps of preliminary metric evaluator module, in accordance with an embodiment of the present invention.

FIG. 2C-1 is a flowchart depicting operational steps performed by a performance indicator calculator module, in accordance with an embodiment of the present invention.

FIG. 2C-2 is a continuation of FIG. 2C-1 flowchart, depicting operational steps performed by a performance indicator calculator module, in accordance with an embodiment of the present invention.

FIG. 2D is a flowchart depicting operational steps of a remediation action routine, in accordance with an embodiment of the present invention.

FIG. 2E is a flowchart depicting operational steps performed by an IT (information technology) service performance module, in accordance with an embodiment of the present invention.

FIG. 3 is a system data flow diagram of an embodiment of the present invention.

FIG. 4 is a functional block diagram in accordance with one embodiment of the present invention.

FIG. 5 is a diagram of an example of an internal decision making process within a ranking engine in accordance with one embodiment of the present invention.

FIG. 6 depicts a block diagram of an IT services computer, several DB (database) computers and a CPPW computer.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a nonexhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. (Note: the term(s) “JAVA” may be subject to trademark rights in various jurisdictions throughout the world and are used here only in reference to the products or services properly denominated by the marks to the extent that such trademark rights may exist.) The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The present invention will now be described in detail with reference to the Figures. The following Figures provide an illustration of one embodiment. The embodiment, taken in part or in whole, does not imply any limitations with regard to the environments in which different embodiments may be implemented.

Some terminology, relevant to some embodiments of the present disclosure, will now be presented in the following paragraphs.

Database-related performance rating: any numerical (or scalar) statistic, heuristic value, metric or other rating related to performance in one or more of the following areas: (i) database throughput performance; (ii) query (or set of queries) performance; and/or (iii) IT-related performance.

Database throughput performance rating includes, but not limited to: (i) any numerical (or scalar) statistic, heuristic value, metric or other rating that relates primarily performance with respect to database throughput; (ii) number of transactions/sec; (ii) number of SQLs/second; (iii) number of reads/second; (iv) number of writes/second; (v) number of inserts/second; (vi) number of updates/second; (vii) number of deletes/second; and (viii) any combination function of the previously mentioned measures.

Query performance rating (may also be referred to herein as an “SQL ranking”): any numerical (or scalar) statistic, heuristic value, metric or other rating that relates primarily to performance of a set of queries, including at least one query. SQL ranking is the rank of an SQL which determines its relative impact as compared to the complete set of SQLs running for the period when the SQ: ranking was measured.

IT services rating (may also be referred to herein as an “IT-related performance”): any numerical (or scalar) statistic, heuristic value, metric or other rating that relates primarily to performance of database-related IT services. IT services administrators build complex IT services rating which, for example, is a function of query rating or a database throughput rating across related and dependent databases. An administrator can build a custom rating as a function of the following: (i) query throughput of the top N ranked queries for a database; (ii) query throughput of the top M ranked queries for another database; and/or (iii) database throughput for a database. An IT services ratings, for one embodiment, is a customized ratings defined by administrators and taking into consideration key measurements across a set of dependent databases for a business application.

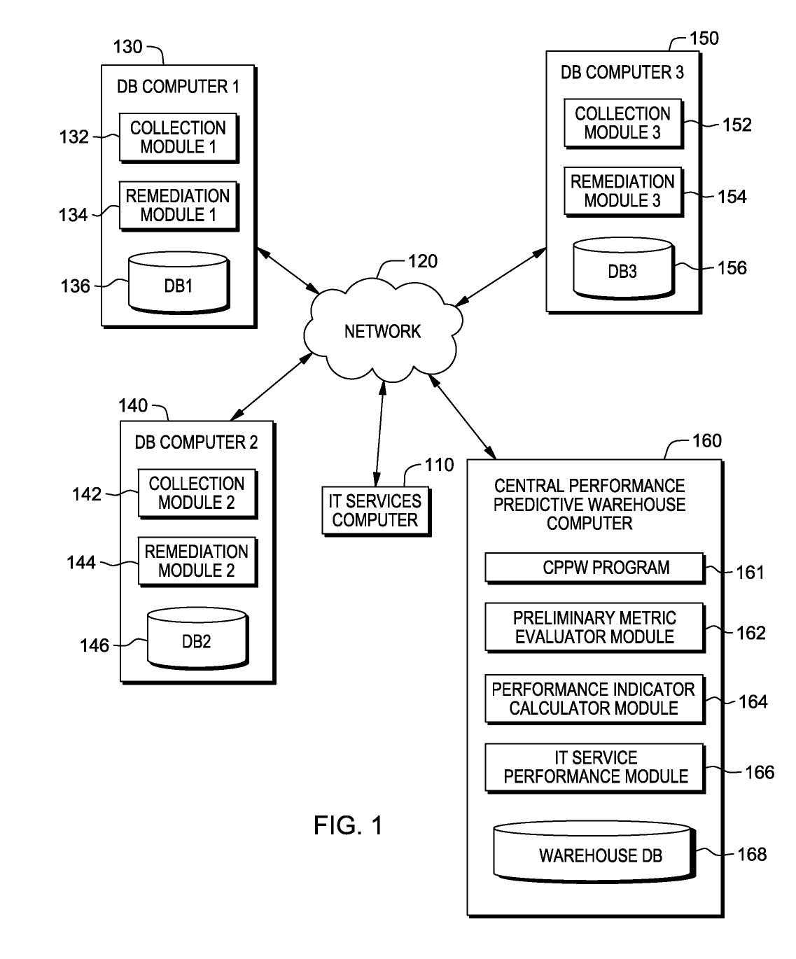

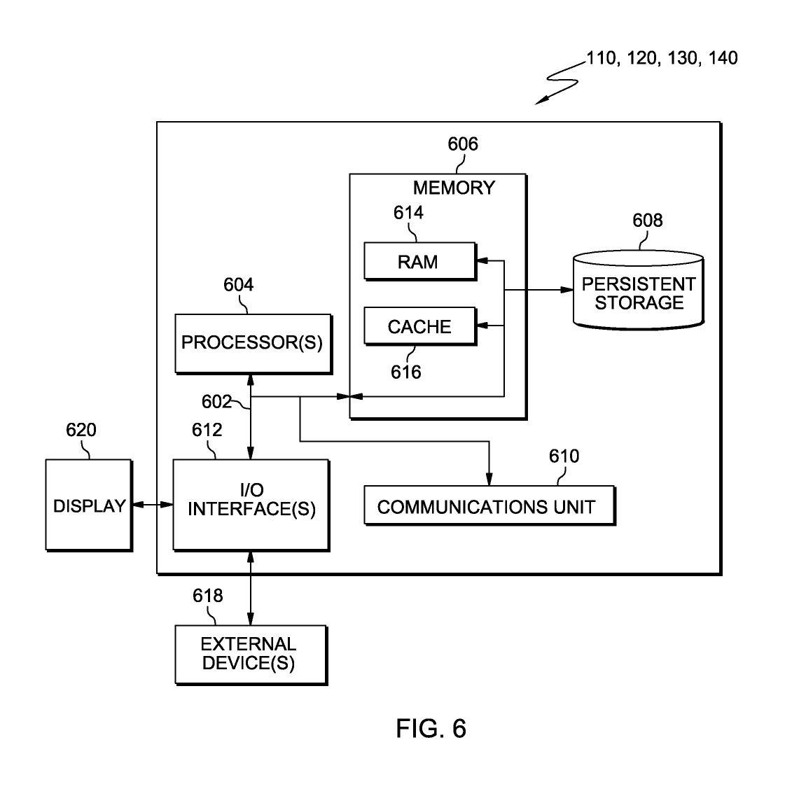

FIG. 1 is a diagram illustrating a distributed data processing environment 100, in accordance with one embodiment of the present invention. Distributed data processing environment 100 includes information technology (IT) services computer 110, database (DB) computers 1, 2 and 3 (reference numerals 130, 140 and 150, respectively), and central performance predictive warehouse (CPPW) computer 160, all interconnected over network 120. In this particular embodiment, IT services computer 110, DB computers 130, 140 and 150, and CPPW computer 160 each include components as depicted in further detail with respect to FIG. 6. In this embodiment, network 120 is a local area network (LAN). Alternatively, the network may be a wide area network (WAN), such as the Internet, or any other network, or combination of sub-networks, that will support communications among IT services computer 110, DB computers 130, 140, 150, and CPPW computer 160. Network 120 may include wired, wireless, and/or fiber optic connections. Distributed data processing environment 100 may include additional servers, computers, or other devices not shown.

In the embodiment of FIG. 1, IT services computer 110, DB computers 130, 140, 150, and CPPW computer 160 are each laptop computers. Alternatively, these computers may take other forms such as tablet computers, netbook computers, personal computers (PC), desktop computers, personal digital assistants (PDA), smart phones, or any programmable electronic devices capable of communicating through a network.

DB computers 130, 140, 150 contain DB1 136, DB2 146, and DB3 156, respectively. DB1 136, DB2 146, and DB3 156 are databases, and may sometimes also be referred to herein as “information stores.” In this embodiment, these databases store information relating to human resources, customer information, employee tasks, marketing plans, accounting, sales, and business data. This stored information is accessed in a controlled manner by and through a database management system.

DB computers 130, 140, 150 respectively contain collection modules 132, 142, 152. The collection modules extract and correlate structured query language (SQL) statements and session metrics from their respectively associated databases and transmit these to CPPW computer 160.

DB computers 130, 140 and 150 respectively contain remediation modules 134, 144, 154. Each remediation module receives DB actions from CPPW computer 160 (for example, DB actions in the form of configuration parameters), and executes those actions on the appropriate database.

CPPW computer 160 contains CPPW program 161, preliminary metric evaluator module 162, performance indicator calculator module 164, IT service performance module 166, and warehouse DB 168. CPPW program 161 spawns processes that run autonomously. Preliminary metric evaluator module 162 identifies if any performance measurements have crossed a threshold. Performance indicator calculator module 164 periodically examines newly stored performance measurements and evaluates SQL statements, database throughputs, and other performance indicators that have been configured in the warehouse DB 168. IT service performance module 166 displays chosen events to IT service personnel in order to take responsive action to alleviate or prevent “database-degrading” throughput. An event identifies that a performance issue has occurred, is in the process of occurring, and/or has the potential to occur.

Performance measurements are throughput metrics and throughput statistics, each metric generally having at least one associated threshold. Example throughput metrics include, but are not limited to: (i) average wait time of a SQL query from initiation to respond; (ii) average read time (I/O (input/output)); (iii) block changes/second; and (iv) number of commits/second. Example throughput statistics include, but are not limited to: (i) number of waits; (ii) number of reads; (iii) number of transactions; (iv) number of blocks changed; and (v) number of user connections established. In this embodiment the thresholds associated with performance measurements are self-regulating. Alternatively, the thresholds may be regulated by an operator authorized to change the thresholds.

Warehouse DB 168 of CPPW 160 is an information store. Warehouse DB 168 is a database that stores performance measurements, SQL executed statements, workload profiles and any other necessary statistics from databases, such as DBs 136, 146, 156, and/or any other database, accessible over network 120, that is similar to DBs 136, 146, 56. The data collected by warehouse DB 168 is collected at intervals, for example every five minutes. These collection intervals are configurable. In one embodiment, warehouse DB 168 is a data file that can be written to and read by processes within CPPW computer 160. Warehouse DB 168 is in the form of a database. As use herein, the term “database” includes, but is not limited to, flat files, and/or any data storage structure that allows access of stored information. Although not necessarily required, “databases” (again, as that term is used herein) provide at least some level of security for their constituent stored information. The information within the information store is obtainable through methods, whether custom or off-the-shelf, that facilitate access by authorized users. For example, such form includes, but is not limited to, a database management system (DBMS).

In system 100, performance indicator calculator module 164 of CPPW computer 160 is further programmed to calculate the following types of performance ratings: (i) database throughput performance ratings; (ii) query performance ratings; and (iii) IT services ratings. Further information about these ratings and how they are calculated will be discussed in detail, below.

Some embodiments of the present invention recognize that tackling DBMS performance issues, in today's large interconnected environment of heterogeneous databases, is mainly confined to implementing best practices and adopting a reactive approach involving diagnosis and tuning on a case by case basis. Some embodiments of the present invention recognize that these confined and/or reactive approaches tend be more pronounced in the IT services domain. The degree of complexity of database management is large and increasing in today's IT services industry, where service providers support hundreds of customer environments with the number of installed databases running into the tens of thousands. Service providers supporting a large number of databases spread across multiple customers find it extremely challenging to detect real-time performance degradation patterns, for the large number of databases, which in turn pose delays to the problem analysis and resolution.

CPPW program 161 can be invoked using a variety of methods, possibly collectively, including, but not limited to: (i) a user operating central performance predictive warehouse computer 160 invokes CPPW program 161; (ii) CPPW program 161 is scheduled to be invoked at a specific time; (iii) CPPW program 161 is invoked when the operating system is booted; and (iv) an computer related event, either operating system or user initiated, occurs, which invokes CPPW program 161. In this embodiment, CPPW program 161 spawns processes that run autonomously.

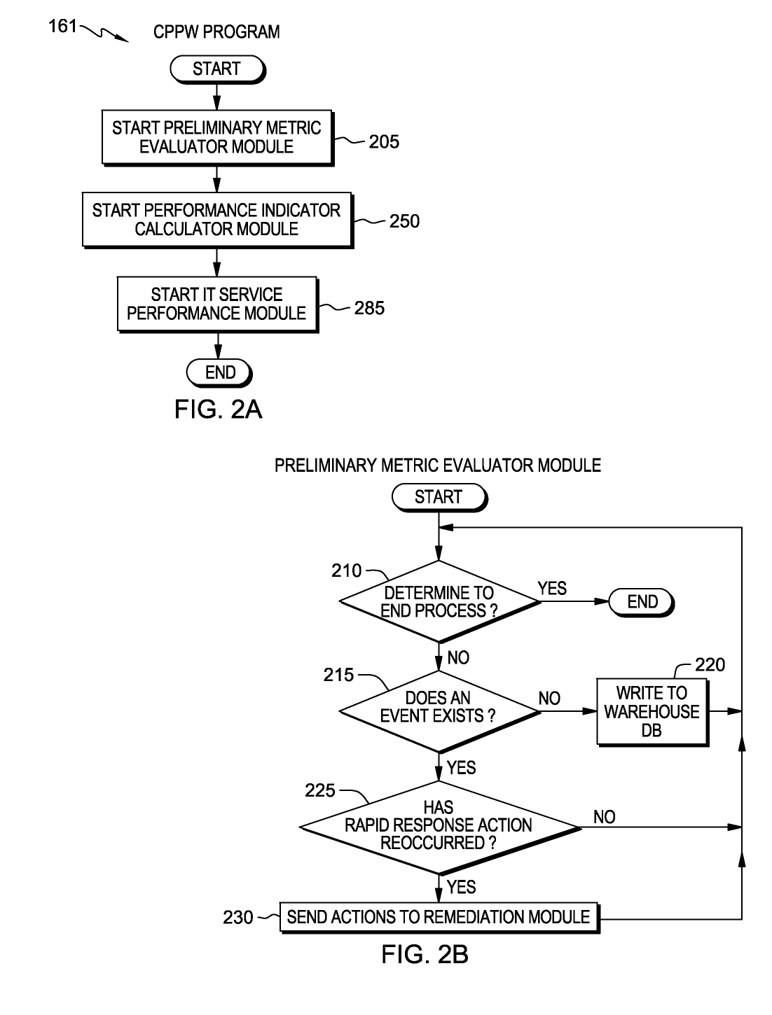

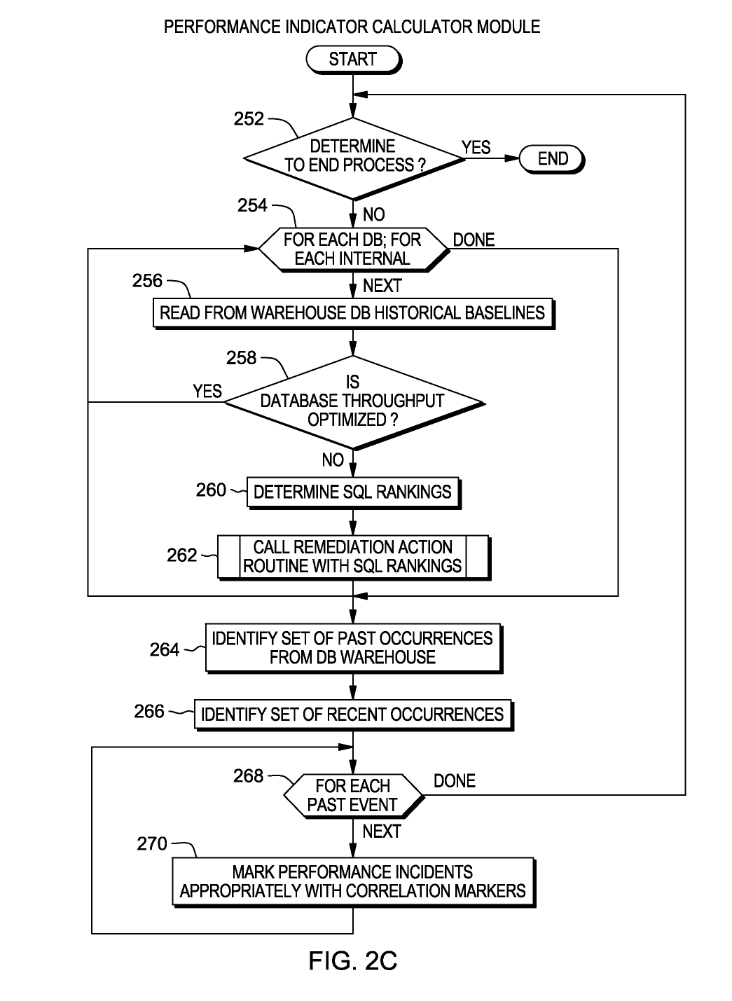

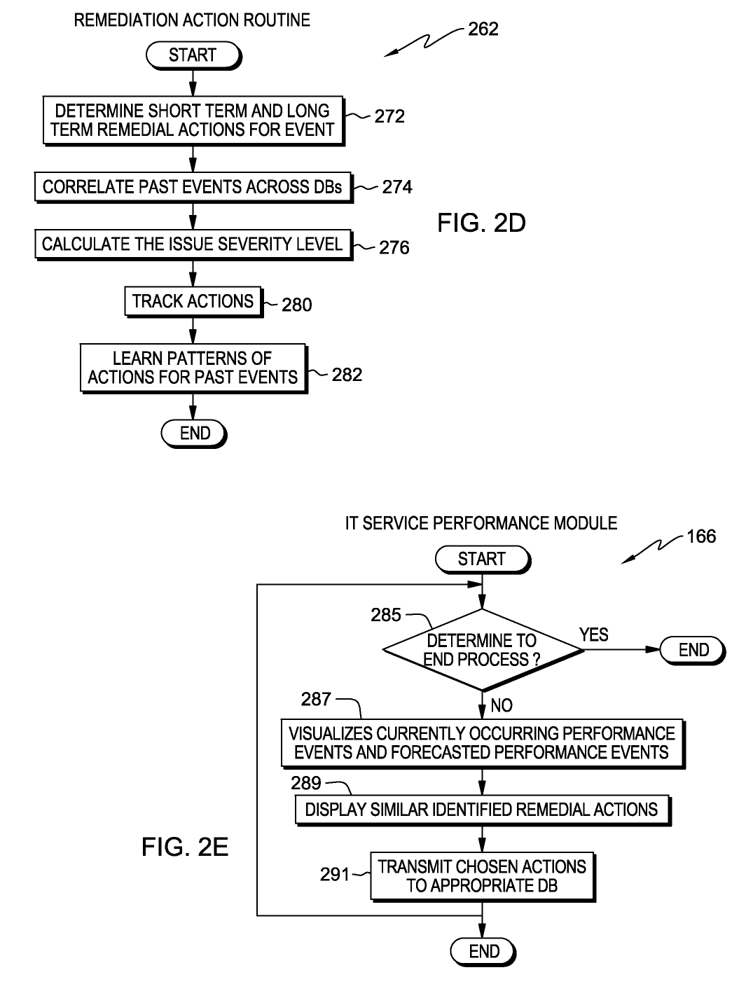

FIG. 2A is a flowchart depicting operational steps of CPPW program 161 for invoking CPPW processes, in accordance with an embodiment of the present invention. In decision step 205, preliminary metric evaluator module 162 is invoked. Preliminary metric evaluator module 162 identifies if any of database-related performance ratings have crossed a threshold.

In step 250, performance indicator calculator module 164 is invoked. Performance indicator calculator module 164 periodically examines newly stored performance measurements and evaluates SQL statements, database throughputs, and other performance indicators that have been configured in the warehouse DB 168. As mentioned above, module 164 also calculates the various types of database-related performance ratings. The various types of database-related performance ratings will be discussed, below, in more detail.

In step 285, IT service performance module 166 is invoked. IT service performance module 166 displays chosen events to IT service personnel in order to take response action to alleviate or prevent database degrading throughput. Performance issues that are occurring, or may potentially occur, with database throughput are known as events. IT service performance module 166 will be discussed shortly in FIG. 2D.

FIG. 2B is a flowchart depicting operational steps of preliminary metric evaluator module 162, in accordance with an embodiment of the present invention.

In decision step 210, preliminary metric evaluator module 162 controls its process state and its mortality. Preliminary metric evaluator module 162 runs periodically. In one embodiment, preliminary metric evaluator module 162 awakes at specific times, such as every 30 minutes, to execute. The time interval between executing and sleeping is configured to optimize preliminary metric evaluator module's 162 data processing. The time interval configuration can be self-regulating or regulated by an operator authorized to change the scheduling. When preliminary metric evaluator module 162 receives an exit signal, such as from the operating system, preliminary metric evaluator module 162 takes the “y” path and gracefully terminates; otherwise, preliminary metric evaluator module 162 takes the “n” path and moves to the next process step.

In decision step 215, preliminary metric evaluator module 162 examines performance measurements and present rapid response actions to determine if any event exists with database throughput. If a present rapid response action does not exists or performance measurements are less than or equal to their associated threshold, preliminary metric evaluator module 162 takes the “n” path and moves to step 220; otherwise, the “y” path is taken and the process moves to step 225.

Performance measurements are received from a collection module, such as collection module 1 132 located on a DB computer 1 130 (see FIG. 1). Communicating with a database computer, and the collection module, can take many forms, as someone in the arts would recognize. The communication methods between the database computer, such as DB computer 1 130, and central performance predictive warehouse computer 160 include, but are not limited to: (i) extensible markup language (XML); (ii) variations of such, one being “beep” (Blocks Extensible Exchange Protocol); (iii) transmission control protocol/internet protocol (TCP/IP) or its derivatives; (iv) process communication, such as messaging; and (v) any communication commands that are to be developed for data handshaking.

A rapid response action identifies a set of possible responses that have been chosen and accepted in prior instances when the same measurement has violated the associated threshold for the same DBMS system. Examples of rapid response actions include, but are not limited to: (i) updating stale statistics; (ii) change execution plans; and (iii) adding a degree of parallelism.

One example that characterizes a stale statistics is when preliminary metric evaluator module 162 determines that the SQL statement throughput has degraded beyond a pre-configured threshold, due to the statistics on one or more of the accessed objects (e.g. tables, indices, partitions, or sub-partitions) not being up to date.

Preliminary metric evaluator module 162 can determine that changing an execution plan can alleviate database throughput issues. A database, such as DB1 136, can have several different execution plans. As requirements and workloads change for a database, certain execution plans can execute more efficiently than others, as determined in the past.

Preliminary metric evaluator module 162 can determine that adding a degree of parallelism can alleviate database throughput issues. Adding a degree of parallelism is calculated as a function of: (a) the percentage of data increase that has occurred in the accessed object, (b) the percentage of degradation that has occurred in the SQL statement throughput, and (c) the number of available parallel slaves available on the database for executing parallel data manipulation language (DML) or queries.

An event identifies that a performance issue has occurred, is in the process of occurring, or has the potential to occur. More specifically, in a typical database query, an action, performed on a database, ultimately runs as transactions comprised of SQL statements. An example of an action is when a customer requests an airline schedule. SQL statements need to perform a number of internal activities to accomplish their task. Examples of internal activities include, but not limited to: (i) fetching whole tables or individual records; (ii) inserting data in tables; (iii) updating data in tables; (iv) reading from an operating system file/block; (v) joining data retrieved from multiple data sources; and (vi) sorting the data. When the waiting time for these internal activities is longer than expected a performance event, known simply as an event, has occurred.

Generally, there are many ways to measure database throughput. For instance, database throughput can be measured by number of transactions/second. Database throughput can be a complex calculation, such as a function of one or more metrics. As an example, an application needs a set of ten different transactions to be completed as one unit. In order to measure the database throughput all transactions will need to complete. Any one of the transactions may hold up the entire unit, thus increasing the application's completion time, thus increasing the database's throughput.

Two examples of SQL statements which can degrade the database throughput are as follows: (i) SQL statements which result in full table scans where an index lookup or range scan is optimal; and (ii) SQL statements access data from their various tables in a certain order and the data is joined with other tables. The join order determine how effective an SQL statement is with regard to performance.

When processing from step 215 takes the “n” path, processing proceeds to step 220 where the performance measurements, received by preliminary metric evaluator module 162, from a collection module will be stored in warehouse DB 168. Performance measurements and any execution plans will be stored in warehouse DB 168.

In decision step 225, preliminary metric evaluator module 162 checks against the list of past rapid response actions to determine whether the same rapid response action may remedy the degraded database throughput. Preliminary metric evaluator module 162 requests from warehouse DB 168 a set of possible rapid response actions that have been chosen and accepted in prior instances when the same metric has violated the associated threshold for the same database system. When preliminary metric evaluator module 162 identifies a past rapid response action the “y” path is taken to set 230; otherwise, preliminary metric evaluator module 162 takes the “n” path and returns back to step 210.

In step 230, the past rapid response action, identified in step 225, is sent to the appropriate database computer, such as DB computer 1 130, for execution in the corresponding remediation module, such as remediation module 134 (see FIG. 1). Sending the rapid response action is similar to communication between the database computer, such as DB computer 1 130, and central performance predictive warehouse computer 160, as described, above, with communication with a collection module.

FIG. 2C-1 is a flowchart depicting operational steps of performance indicator calculator module 164 (see FIG. 1).

In decision step 252, performance indicator calculator module 164 controls its process state and its mortality. Performance indicator calculator module 164 runs periodically. In one embodiment, performance indicator calculator module 164 awakes at specific times, such as every 30 minutes, to execute. The time interval between executing and sleeping is configured to optimize performance indicator calculator module 164 data processing. The time interval configuration can be self-regulating or regulated by an operator authorized to change the scheduling. Performance indicator calculator module 164 receives an exit signal, such as from the operating system, performance indicator calculator module 164 takes the “y” path and gracefully terminates; otherwise, performance indicator calculator module 164 takes the “n” path and moves to the next process step.

In step 254, performance indicator calculator module 164 initiates two loops, one loops through each database on network 120, and an inter-loop loops through each time interval associated with each database. Each database, such as DB1 136 on DB computer 1 130 (see FIG. 1), contains a set of configurable intervals. Example intervals include, but are not limited to: (i) five minutes; (ii) fifteen minutes; and (iii) one hour. When all databases have been examined the loop end and performance indicator calculator module 164 moves to step 264 (see FIG. 2C-2).

In step 256, performance indicator calculator module 164 reads historical baselines from warehouse DB 168. Each database on network 120, such as DB1 136 (see FIG. 1), has an associated historical baseline. Historical baselines indicate past database performance and are used as a measuring stick to compare current database performance. Historical baselines contain both database level and application level baseline throughputs.

In decision step 258, performance indicator calculator module 164 determines whether database throughput is optimized. Performance measurements, which represent current throughput, are compared against the historical baselines for the associated database. Performance measurements are compared at both the database level and at the application level. When database throughput is not optimized, at either the database level or the application level, performance indicator calculator module 164 takes the “n” path to process step 260; otherwise, performance indicator calculator module 164 takes the “y” path and loops back to step 254.

In step 260, performance indicator calculator module 164 determines the SQL rankings. The impact of each SQL statement and each transaction is evaluated at an end-to-end application level. SQL ranking is determined by how much a particular SQL statement impacts a corresponding database, such as DB 136, throughput. More specifically, the relative impact of each component SQL statement and each transaction, executed in each database, is determined and ranked. Using the SQL ranking, for one embodiment of the present invention, an IT service administrator can easily determine the top SQL statements that contribute to degrading overall database throughput.

In one embodiment, the SQL statements are ranked according to the contribution to the database throughputs for each interval of time. The interval of time is configurable, for example: five minutes, fifteen minutes, or one hour, et cetera. A simple example, for one embodiment, is as follows. SQL statements A, B, C, D impact the throughput of a database, between 10 AM-10:15 AM in the following proportions: 65%, 5%, 10%, and 20%. SQL rankings in this case are: (i) first (highest), SQL A; (ii) second, SQL D; third, SQL C; and (iv) fourth (lowest), SQL B.

In step 262, performance indicator calculator module 164 calls remediation action routine 262 with a parameter representing the SQL rankings identified in step 260. Remediation action routine 262 identifies opportunities in either increasing or throttling the throughput of individual component SQL statements with the overall objective of optimizing the end-to-end application throughput.

Continuing on to FIG. 2C-2, which is a continuation of the FIG. 2C-1 flowchart, depicting operational steps of performance indicator calculator module 164, processing continues to step 264. In step 264, performance indicator calculator module 164 identifies a set of past occurrences from warehouse DB 168. The set of past occurrences are SQL statement throughput values +/−x % of earlier SQL statement throughput performance measurements and where the SQL statement throughput was identified as being degraded. These past occurrences SQL statement throughputs are known as past events. X % is tunable by IT support administrators.

In step 266, performance indicator calculator module 164 identifies a set of past performance measurements that have values +/−y % of the current throughput performance measurements. Y % is tunable by IT support administrators. Past performance measurements that have values +/−y % of the current throughput performance measurements as known as performance incidents.

In step 268, performance indicator calculator module 164 loops for each of the past events from step 264.

In step 270, performance indicator calculator module 164 marks each entry in the set of performance measurements as a correlation marker. A correlation marker is a means to identify the set of performance measurements with a corresponding SQL ranked statement. There may be several correlation markers for an event.

Turning to FIG. 2D, which is a flowchart depicting operational steps of remediation action routine 262, processing begins at step 272. In step 272, remediation action routine 262 determines short-term and long-term remedial actions for an event. A remedial action is a set of steps undertaken to resolve degraded database throughput performance. Some examples of possible remedial actions are: (i) modifying an SQL statement to use a better execution plan; (ii) collecting fresh object statistics to allow for better execution plans; and (iii) changing configuration parameters which influence the behavior of the database optimizer engine. Remedial actions are similar to rapid response actions, but unlike rapid response actions, remedial actions cannot be executed in real-time. Remedial actions have to be reviewed and executed by an administrator of the associated event database, such as DB1 136. Remedial actions can be executed immediately by the administrator or scheduled to execute at a given time, possibly when use of the database is offline.

In step 274, remediation action routine 262 identifies past remedial actions taken across any of the DBMS systems supported by a given IT service company and having the same correlation markers in the order of their SQL rankings and flags the correlation markers as potential actions for later visualization in IT services computer 110 (see FIG. 1).

In step 276, remediation action routine 262 calculates the issue severity level. Issue severity level identifies the relative severity of an event relative to other events that have occurred in the past. In other embodiments, issue severity level is known as issue criticality level. Issue severity level of the event is a function of: (i) SQL ranking for the specific database, such as DB1 136; (ii) pre-configured database severity levels to the customer's business; and (iii) forecasted degradation of the database throughput due to the identified correlation markers from past events, which are stored in the Warehouse DB 168. A visual display of the issue severity level at the IT services console 110 is stored in Warehouse DB 168. Issue severity level helps IT administrators to identify opportunities in either increasing or throttling the throughput of individual component SQL statements with the overall objective of optimizing the end to end application throughput.

In step 278, remediation action routine 262 tracks the remedial actions. Remediation action routine 262 keeps track of past remedial actions. Remedial actions are ranked as a function of the number of times they have been flagged as possible actions and the number of times they have been accepted by the administrators for the specific database, such as DB1 136. Tracking data can take any form that facilitates storage and retrieval of information. Examples of the tracking method include, but are not limited to: (i) utilizing environmental variables; (ii) utilizing a database management system (DBMS) such as: (a) a relational database, (b) hierarchical database, (c) object-oriented database, (d) XML (Extendable Markup Language) database, etc.; (iii) utilizing a flat file; (iv) utilizing a table lookup scheme, such as a hash table software; or (v) utilizing any custom or off-the-shelf software that manages the tracking data.

In step 280, remediation action routine 262 learns patterns of actions associated with past events. Remediation action routine 262 learns patterns of remedial actions accepted by administrators of databases, such as DB1 136, for past events in which correlation markers match and SQL rankings are within +/−n % of each other. Remediation action routine 262 establishes heuristic relationships between the correlation markers for different databases stored in warehouse DB 168. Establishing heuristic relationships allows an event associated with a specific database to be generalized to several databases. Determining patterns of related database events, across several databases, possibly over several time intervals, allows CPPW program 161 (see FIG. 1) to utilize database throughput solutions for future similar events.

Turning to FIG. 2E, which is a flowchart depicting operational steps of IT service performance module 166, processing begins at step 285. In decision step 285, IT service performance module 166 controls its process state and its mortality. IT service performance module 166 runs periodically. In one embodiment, IT service performance module 166 awakes at specific times, such as every 30 minutes, to execute. The time interval between executing and sleeping is configured to optimize IT service performance module 166 data processing. The time interval configuration can be self-regulating or regulated by an operator authorized to change scheduling. IT service performance module 166 receives an exit signal, such as from the operating system, IT service performance module 166 takes the “y” path and gracefully terminates; otherwise, IT service performance module 166 takes the “n” path and moves to the next process step.

In step 287, IT service performance module 166 visualizes currently occurring events and forecasted events to the IT service administrators. IT service performance module 166 presents to the IT service administrators the events, whether currently occurring or forecasted to eventually occur. The top contributors to the overall database throughput are displayed, and thus, IT services administrators can quickly determine the level of severity of the SQL statements whose throughputs have degraded or are in the process of degradation.

In addition, the issue severity level is retrieved from warehouse DB 168 and displayed at IT services console 110. Issue severity level helps IT administrators to identify opportunities in either increasing or throttling the throughput of individual component SQL statements with the overall objective of optimizing the end to end application throughput.

In step 289, IT service performance module 166 displays to IT service administrators remedial actions taken for similar events. Remedial actions are displayed to IT service administrators at IT services console 110.

In step 291, IT service performance module 166 transmits appropriate actions to the appropriate database. The IT service administrators will alter database execution as necessary.

Now that the embodiment(s) of FIGS. 1 to 2E have been fully discussed, some additional discussion and embodiments of the present invention will be discussed in the following paragraphs.

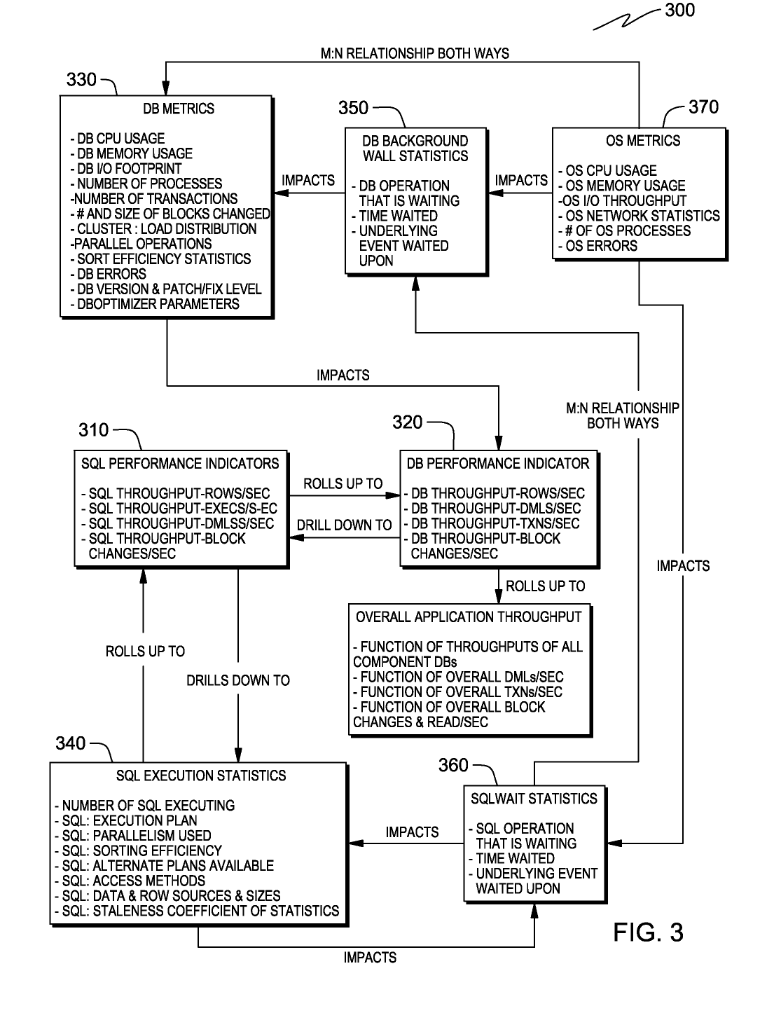

Turning to FIG. 3, process 300, is a system data flow diagram of an embodiment of the present invention. The FIG. 3 depicts the complex nature of interdependencies among metrics of the OS (operating system), DB (database) and at the individual structured query language statement level to the performance indicators. SQL performance indicators 310 at level SQL roll-up to the indicators at DB performance indicators 320. The method described in this disclosure proposes that all the categories of metrics, statistics and indicators at DB metrics 330, as well as at the individual SQL execution statistics 340 will be captured at regular pre-determined and configurable intervals (of measurement) from each database. An “individual SQL” is a single instance of a single query to the database system that gets a single response from the database system. Similarly, DB background wait statistics 350 and SQL wait statistics 360 along with OS metrics 370 will be captured as part of the snapshot. Further, several of the performance indicators as shown in SQL performance indicators 310 and DB performance indicators 320 will be derived from a combination of one or more metrics and indicators.

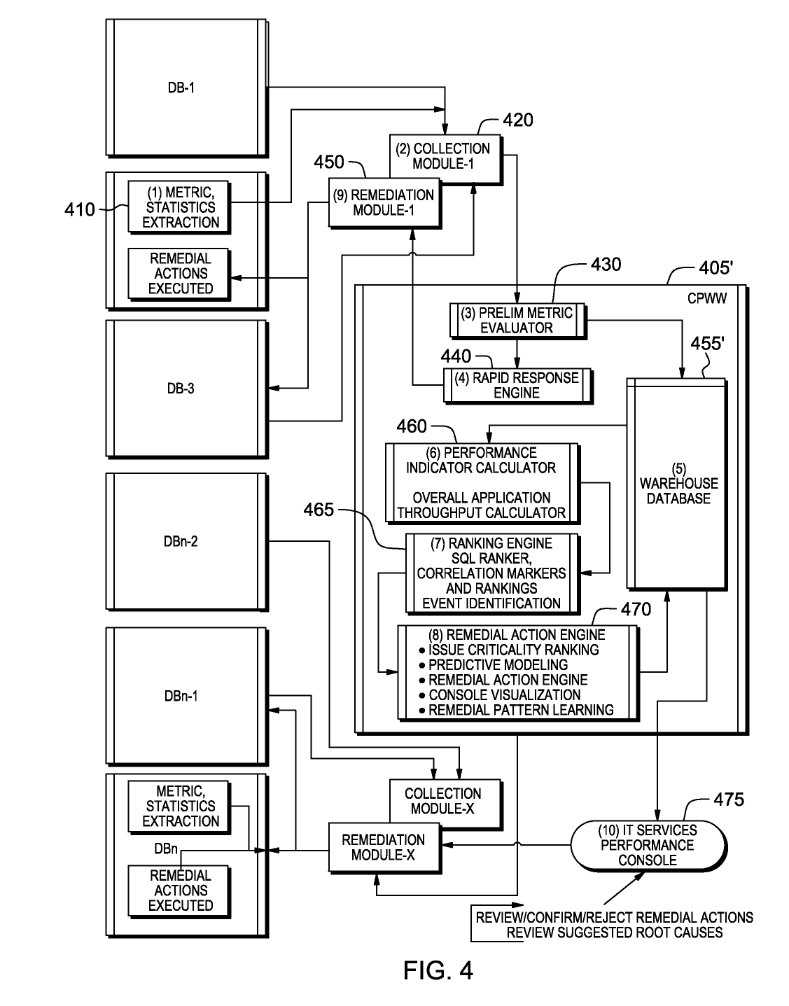

SQL throughput values 310 will be rolled up to the DB level to arrive at the DB performance indicators 320 for each interval of measurement. The metrics depicted in the chart are a sample chosen from a wide array of other available metrics at the SQL and the database level. For each measurement that is taken, a snapshot of all the identified metrics, statistics are taken and tagged with the timestamp of the measurement and stored into CPPW 405 (as shown in FIG. 4). This snapshot will capture from each individual database, the set of SQL (and their associated metrics) from the last measurement snapshot until the current time. This ensures that the CPPW 405 has a continuous stream of metrics and derived indicators for each database that is enrolled in the CPPW 405 for predictive analysis and modeling.

FIG. 4 illustrates database, SQL, and session metrics 410 are extracted from the DBMS by a collection module 420 which then transmits them to preliminary metric evaluator 430. Preliminary metric evaluator 430 identifies if any of the metrics have crossed a threshold and if so it then passes this information to rapid response engine 440.

Rapid response engine 440 checks against the list of rapid response actions identifies a set of possible actions that are chosen and accepted in prior instances when the same metric has violated the threshold for the same DBMS system. If actions are identified, those actions will be transmitted to the remediation module-1 450 for immediate execution on the DBMS systems identified. If either no rapid response actions have been identified or if no identified metric has exceed a threshold, the metric and statistics information received by preliminary metric evaluator 430 will be stored in the historical warehouse database 455.

Performance indicator calculator 460 periodically examines newly stored metrics and statistics and evaluates the SQL and DB throughputs and other performance indicators that are configured in the warehouse database 455. In ranking engine 465, the performance indicators are compared against past historical baselines to determine if the SQL throughput or DB throughput has exceeded a pre-configured threshold.

In addition, the SQLs rankings are re-evaluated according to their contribution towards the DB throughput for each interval and for each DBMS. The SQL rankings help IT services companies quickly determine the level of criticality of the SQLs whose throughputs have degraded or are in the process of degradation and are among the top-N contributors to the overall DB throughput.

Additionally, throughput goals can be set at either an individual database level or an overall application level. When the goal is set to optimizing throughput at an overall application level, the ranking engine determines the relative impact of each component SQL and transaction, executed in each database, and determines the impact of each SQL and transaction at an overall application level. This allows remedial action engine 470 to identify opportunities in either increasing or throttling the throughput of individual component SQLs with the overall objective of optimizing the end to end application throughput.

In addition, ranking engine 465, identifies past occurrences where the SQL throughput value was in the vicinity of + or −x % of earlier SQL throughputs and where the SQL throughput was identified as being degraded. For all of these past occurrences, ranking engine 465 then identifies the set of metrics and statistics collected in collection module-1 420 that has values in the vicinity of + or −y % of the current value. The identified set of such metrics and statistics are marked with ranked correlation markers with the current degraded SQL throughput which serves to inform the IT Services companies the level of impact that the current values of the identified set of metrics and statistics have in relation to the degraded SQL and/or the DB throughput.

Remedial action engine 470 further identifies the said occurrence as an event and then proceeds to determine short term and long term remedial actions for the identified event. Remedial action engine 470 also identifies past remedial actions taken across any of the DBMS systems supported by an IT services company and having the same correlation markers in the order of their correlation rankings and flags them as potential actions for later visualization in IT services performance console 475.

Remedial action engine 470 also calculates the issue criticality levels of the identified event as a function of: (i) SQL Rank for the specific DBMS; (ii) pre-configured DBMS criticality levels to the customer's business; and (iii) forecasted degradation of the DB throughput due to the identified correlation markers from past issues and incidents as stored in warehouse database 455 and then constructs the visual display of IT services performance console 475 and stores the display in the warehouse database 455.

An additional function performed by the remedial action engine 470 is to learn patterns of remedial actions accepted by operators in the past for events whose correlation markers match and whose correlation rankings are within + or −n % of each other. These remedial actions are also ranked as a function of the number of times they have been flagged as possible actions and the number of times they have been accepted by the operator for the specific DBMS.

IT service performance console 475 visualizes the currently occurring performance “events”, forecasted performance “events” and ranks them according to the issue criticality levels calculated by remedial action engine 470. In addition, identified remedial actions and remedial actions taken for events with similar (within + or −n %) of the correlation ranks are displayed for the operator to choose from. The remedial actions chosen by the said operator of the said IT services company are then transmitted for execution on the DBMS where the performance event has occurred or is projected to occur.

Another embodiment of a remedial response action determined by either rapid response engine 440 or remedial action engine 470 is for the engine to determine the SQL throughput has degraded beyond a pre-configured threshold due to the statistics on one or more of the accessed objects not being up to date. The engine determines one or more objects (i.e. tables, indices, partitions or sub-partitions) accessed by the SQL execution plan has stale statistics which have not been renewed since a pre-configured percentage of the data in the object has changed. The engine can make this determination by referring to the date when the statistics were last gathered which is available as an object level metric from database metrics 410 and by checking the data changes that have occurred since that date by referring to the date change metric that is collected from the database metrics 410 since the time the statistics were last collected.

Another embodiment of a remedial response action determined by either rapid response engine 440 or remedial action engine 470 is one where the engine determines that the same SQL whose throughput currently has degraded beyond a pre-configured threshold, has a different execution plan which was used to produce higher SQL throughputs in the past and to execute a remedial action on the database instructing the database optimizer to use the alternate SQL plan in cases where the database is able to accept such instructions for forcing usage of alternate SQL plans.

Another embodiment of a remedial response action determined by either rapid response engine 440 or remedial action engine 470 is for the engine to determine that the size of the objects being accessed by the SQL that has increased by a pre-configured threshold since the last time it had evidenced normal throughputs and hence to deploy a remedial action which involves instructing the database to modify the plan of the SQL by making use of a degree of parallelism which is calculated as a function of: (i) the percentage of data increase that has occurred in the accessed object; (ii) the percentage of degradation that has occurred in the SQL throughput; and (iii) the number of available parallel slaves available on the database for executing parallel DML or queries.

One embodiment of a remedial response action determined by remedial action engine 470 is presented to the operator as a suggestion in IT service performance console 475 is one where the engine recommends scheduling a de-fragmentation of an identified object whose fragmentation index has exceed a pre-configured threshold.

Another embodiment of a remedial response action determined by remedial action engine 470 that is presented to the operator as a suggestion in IT service performance console 475 is one where the recommended actions is fetched from the database in question in cases where the database has the capability of performing diagnostics on its own performance characteristics and provide recommendations.

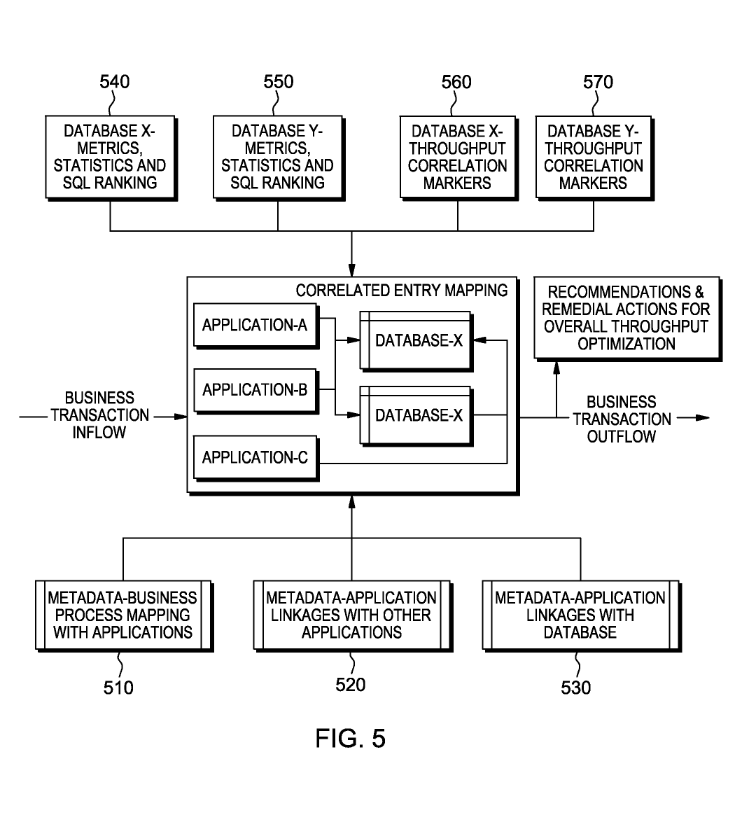

FIG. 5 is an example of an internal decision making process within a ranking engine in accordance with one embodiment of the present invention. FIG. 5 illustrates how the ranking engine makes decisions, for one embodiment of the present invention, when the goal is to optimize the throughput of an application which comprises multiple databases. FIG. 5 illustrates the process by which the ranking engine 465 (see FIG. 4) determines remediation actions when it determines that a performance event (performance slow-down) has occurred for one or more databases which are used within the same application. Ranking engine 465 reads the metadata from: (i) metadata—business process mapping with applications 510, (ii) metadata—application linkages with other applications 520, and (iii) metadata—application linkages with databases 530; metrics and other information for the individual databases: (i) database x—metrics statistics and SQL ranking 540, (ii) database y—metrics statistics and SQL ranking 550, (iii) database x—throughput correlation markers 560, and (iv) database y—throughput correlation markers 570; and SQL ranking from the warehouse database (not shown). Ranking engine 465 makes decisions on how to optimize the overall throughput of the application which has slowed down. For example, ranking engine 465 may determine that the database “x” is aggressively sending data to database “y” which is slowing down, and hence recommend actions which will result in throttling the data output from database “x” to database Y.

A few terms will now be defined. A database-related operation is a single operation that is performed by or in a database system and uses some level of system resources; for example, a response to a single instance of a single SQL query is one example of a database-related operation. A database-related transaction is a set of queries and/or data changes which is executed as one logical end to end step; that is, the changes done within a transaction are all committed to the database together. Database-related transactions are essentially a grouped batch of changes to the database system. A business transaction can comprise of multiple database-related transactions to multiple databases. So, a business transaction consists of 1 or more database-related transactions (to one or more databases) each database-related transaction is a set of SQL queries, updates, inserts, deletes and/or the like. A “contributor” may take the form of a database-related transaction or a database-related operation, depending upon the desired granularity that is to be used in ranking, problem identification and the like according to various aspects of the present invention.

FIG. 6 depicts a block diagram of components that is used in each of the following computers previously discussed in connection with FIG. 1: IT services computer 110, DB computers 130, 140 and 150, and CPPW computer 160.

IT services computer 110, DB computers 130, 140 and 150, and CPPW computer 160, as in accordance with an illustrative embodiment of the present invention. It should be appreciated that FIG. 6 provides only an illustration of one implementation and does not imply any limitations with regard to the environments in which different embodiments may be implemented. Many modifications to the depicted environment may be made.

Distributed data processing environment computers include communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 606 and persistent storage 608 are computer-readable storage media. In this embodiment, memory 606 includes random access memory (RAM) 614 and cache memory 616. In general, memory 606 can include any suitable volatile or non-volatile computer-readable storage media.

CPPW program 161 is stored in persistent storage 608 for execution by one or more of the respective computer processors 604 via one or more memories of memory 606. In this embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer-readable storage medium that is also part of persistent storage 608.

Communications unit 610, in these examples, provides for communications with other data processing systems or devices, including resources of enterprise grid (not shown) and distributed data processing environment computers. In these examples, communications unit 610 includes one or more network interface cards. Communications unit 610 may provide communications through the use of either or both physical and wireless communications links. CPPW program 161 may be downloaded to persistent storage 608 through communications unit 610.

I/O interface(s) 612 allows for input and output of data with other devices that may be connected to distributed data processing environment computers. For example, I/O interface 612 may provide a connection to external devices 618 such as a keyboard, keypad, a touch screen, and/or some other suitable input device. External devices 618 can also include portable computer-readable storage media such as, for example, thumb drives, portable optical or magnetic disks, and memory cards. Software and data used to practice embodiments of the present invention, e.g., CPPW program 161, can be stored on such portable computer-readable storage media and can be loaded onto persistent storage 608 via I/O interface(s) 612. I/O interface(s) 612 is also connect to a display 620.

Display 620 provides a mechanism to display data to a user and may be, for example, a computer monitor.

The programs herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based devices that perform the specified functions or acts, or combinations of special purpose hardware and computer instructions.

What is claimed is:

1. A method for use with a database system including at least one database, with the database system being configured to provide a single application, and with the system being subject to a plurality of database-related operations and database-related transactions, the method comprising:
determining a contribution to system workload for each contributor of a plurality of contributors; and
selecting a remedial action based, at least in part, upon the contributions to system workload of the contributors;
wherein:
the plurality of contributors are selected as one of the following: the plurality of database-related operations, or the plurality of database-related transactions.

2. The method of claim 1 further comprising:
ranking at least some of the contributors of the plurality of contributors based upon, at least, contribution to system workload;
wherein:
the selection of the remedial action is further based, at least in part, on the ranking of the contributors.

3. The method of claim 1 further comprising:
correlating metrics with each ranked contributor using a correlation marker; and
determining a level of impact that each metric has on response time and/or throughput of at least one contributor of the plurality of contributors based, at least in part, upon the correlation marker.

4. The method of claim 1 further comprising:
identifying a first performance issue has the potential to occur based, at least in part, upon the contributions to system workload of the contributors of the plurality of contributors.

5. The method of claim 4 further comprising:
identifying a relative severity of the first performance issue relative to other performance issues that have occurred in the past.

6. The method of claim 1 further comprising:
identifying a first performance issue based, at least in part, upon the contributions to system workload of the contributors;
wherein:
the selection of a remedial action includes determination of a first short term remedial action and a first long term remedial action for the first performance issue.

7. A computer program product for use with a database system including at least one database, with the database system being configured to provide a single application, and with the system being subject to a plurality of database-related operations and database-related transactions, the computer program product comprising software stored on a software storage device, the software comprising:
first program instructions programmed to determine a contribution to system workload for each contributor of a plurality of contributors; and
second program instructions programmed to select a remedial action based, at least in part, upon the contributions to system workload of the contributors;
wherein:
the plurality of contributors are selected as one of the following: the plurality of database-related operations, or the plurality of database-related transactions; and
the software is stored on a software storage device in a manner less transitory than a signal in transit.

8. The product of claim 7 wherein the software further comprises:
third program instructions programmed to rank at least some of the contributors of the plurality of contributors based upon, at least, contribution to system workload;
wherein:
the selection of the remedial action is further based, at least in part, on the ranking of the contributors.

9. The product of claim 7 wherein the software further comprises:
third program instructions programmed to correlate metrics with each ranked contributor using a correlation marker; and
fourth program instructions programmed to determine a level of impact that each metric has on response time and/or throughput of at least one contributor of the plurality of contributors based, at least in part, upon the correlation marker.

10. The product of claim 7 wherein the software further comprises:
third program instructions programmed to identify a first performance issue has the potential to occur based, at least in part, upon the contributions to system workload of the contributors of the plurality of contributors.

11. The product of claim 10 further comprising:
fourth program instructions programmed to identify a relative severity of the first performance issue relative to other performance issues that have occurred in the past.

12. The product of claim 7 further comprising:
third program instructions programmed to identify a first performance issue based, at least in part, upon the contributions to system workload of the contributors;
wherein:
the selection a remedial action, by the second program instructions, includes determination of a first short term remedial action and a first long term remedial action for the first performance issue.

13. A computer system for use with a database system including at least one database, with the database system being configured to provide a single application, and with the system being subject to a plurality of database-related operations and database-related transactions, the computer system comprising:
a processor(s) set; and
a software storage device;
wherein:
the processor set is structured, located, connected and/or programmed to run software stored on the software storage device;
the software comprises:
first program instructions programmed to determine a contribution to system workload for each contributor of a plurality of contributors, and
second program instructions programmed to select a remedial action based, at least in part, upon the contributions to system workload of the contributors; and
the plurality of contributors are selected as one of the following: the plurality of database-related operations, or the plurality of database-related transactions.

14. The system of claim 13 wherein the software further comprises:
third program instructions programmed to rank at least some of the contributors of the plurality of contributors based upon, at least, contribution to system workload;
wherein:
the selection of the remedial action is further based, at least in part, on the ranking of the contributors.

15. The system of claim 13 wherein the software further comprises:
third program instructions programmed to correlate metrics with each ranked contributor using a correlation marker; and
fourth program instructions programmed to determine a level of impact that each metric has on response time and/or throughput of at least one contributor of the plurality of contributors based, at least in part, upon the correlation marker.

16. The system of claim 13 wherein the software further comprises:
third program instructions programmed to identify a first performance issue has the potential to occur based, at least in part, upon the contributions to system workload of the contributors of the plurality of contributors.

17. The system of claim 16 further comprising:
fourth program instructions programmed to identify a relative severity of the first performance issue relative to other performance issues that have occurred in the past.

18. The system of claim 13 further comprising:
third program instructions programmed to identify a first performance issue based, at least in part, upon the contributions to system workload of the contributors;
wherein:
the selection a remedial action by the second program instructions includes determination of a first short term remedial action and a first long term remedial action for the first performance issue.
